(19) United States
(12) Patent Application Publication
(10) Pub. No.: US 2026/0311206 A1
(43) Pub. Date: Oct. 8, 2026

(54) Cryptocurrency Incentive or Reward for Business Transactions

(71) Applicants: James Timothy Byers, Las Vegas, NV (US); Charles Joseph Byers, Browns Summit, NC (US)

(72) Inventors: James Timothy Byers, Las Vegas, NV (US); Charles Joseph Byers, Browns Summit, NC (US)

(21) Appl. No.: 19/169,992

(22) Filed: Apr. 3, 2025

(51) Int. Cl. G06Q 30/0207; G06Q 30/0279

(52) U.S. Cl. CPC G06Q 30/0215; G06Q 30/0279; G06Q 2220/10

(57) ABSTRACT

Herein, methods are described for using cryptocurrency to reward and/or incentivize donations, sales, and all forms of trade. The underlying transaction(s) does not need to be in cryptocurrency but can be any form of trade or agreement. The reward mechanism can be customized based on the transaction type and value, ensuring flexibility and adaptability to various business models.

### BACKGROUND OF THE INVENTION

In the digital age, many organizations leverage internet-based social networks and social media platforms to disseminate information and facilitate business operations. These platforms not only enable communication but also serve as channels for digital sales and donation receipts. Organizations often incentivize engagement by offering rewards such as books, plaques, memorabilia, and other goods, either free of charge or at a reduced cost.

In the realm of internet-based financial transactions, cryptocurrency has emerged as a prominent medium of exchange. This digital currency exists in various forms, including digital coins, tokens, and meme-coins. The versatility of cryptocurrency allows it to be utilized across a wide array of transactions, provided that the involved parties accept the specific type of cryptocurrency being used.

To streamline the use of cryptocurrency, various online exchanges have been established. These platforms enable users to swap one type of cryptocurrency for another or to sell their digital currency for cash, aka Fiat Currency. Additionally, online facilities have emerged that allow cryptocurrency holders to generate passive income through staking, loans, and liquidity pools. These mechanisms enhance the financial appeal and desirability of cryptocurrencies, making them valuable assets in the digital economy.

Organizations can harness the power of cryptocurrency by integrating it into their reward and incentive programs. Organizations could drive engagement and foster a deeper connection with their audience by offering digital tokens and coins (cryptocurrency) as part of loyalty programs or as incentives for completing certain actions. The flexibility and innovation associated with cryptocurrency make it a compelling choice for modern business strategies.

### SUMMARY OF THE INVENTION

Cryptocurrency can be utilized as a reward or incentive in business transactions by offering digital coins, tokens, or meme-coins to customers or other parties involved in the transaction. These cryptocurrencies can either pre-exist or be created specifically for the invention. The amount of cryptocurrency awarded can vary based on the value of the underlying transaction, a predetermined schedule, or an arrangement between the parties. This approach not only incentivizes engagement in business transactions but also provides a modern and innovative way to reward participants.

### BRIEF DESCRIPTION OF DRAWINGS

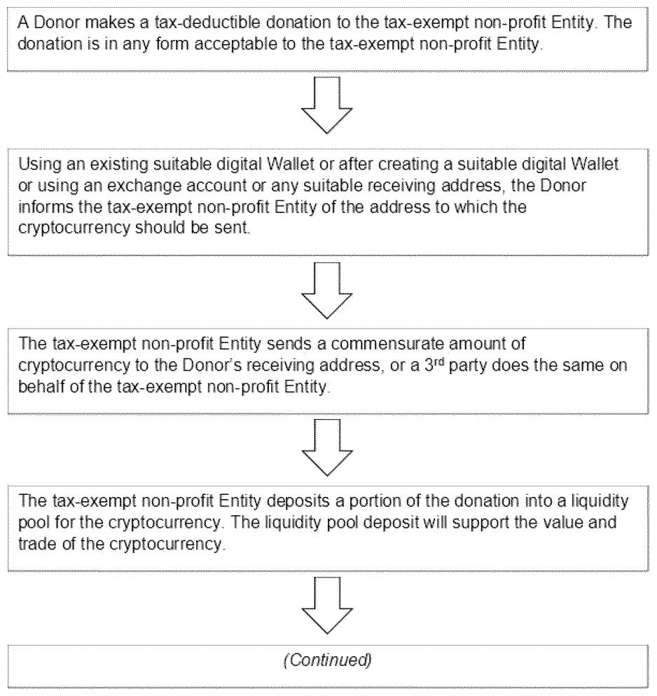

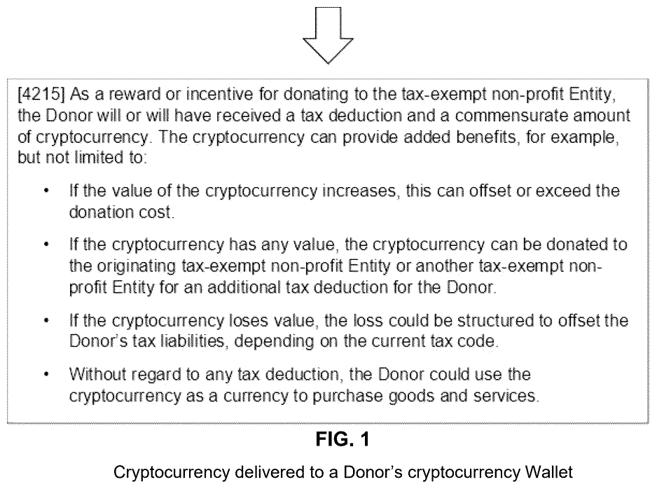

The process diagrams in FIG. 1 to FIG. 4 show four (4) possible uses of the invention. The implementation of the invention is not limited to the four business applications presented. The invention can be used to make any business transaction or follow-on transaction(s) more likely to occur.

Drawings for FIG. 1. The process diagrams in FIG. 1 envision the use of the invention as a reward for a donation to a tax-exempt non-profit Entity from a Donor who uses an online cryptocurrency Wallet.

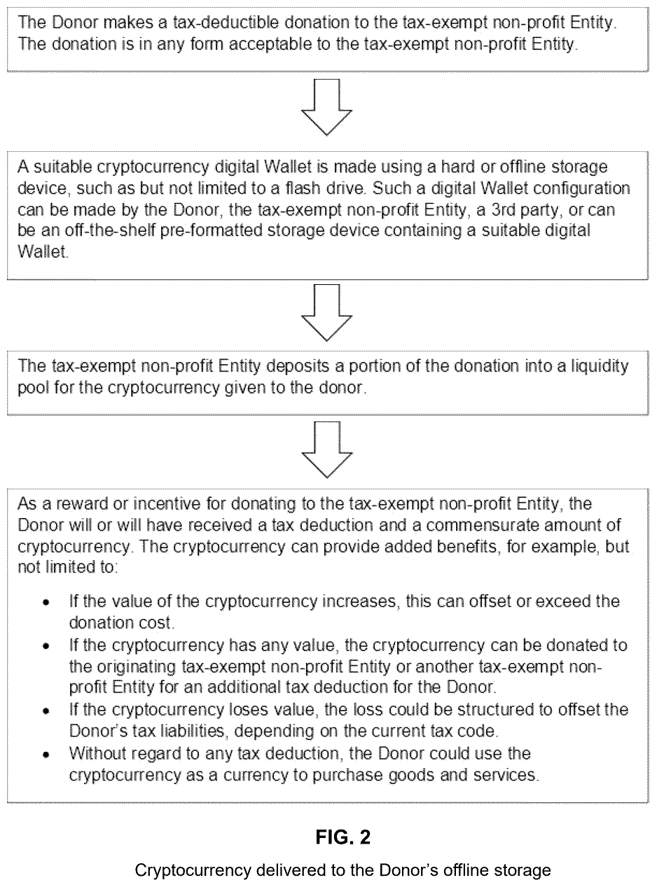

Drawings for FIG. 2. The process diagrams in FIG. 2 envision the use of the invention as a reward for a donation to a tax-exempt non-profit Entity from a Donor who uses an offline cryptocurrency Wallet, such as on a USB flash drive, aka cold storage.

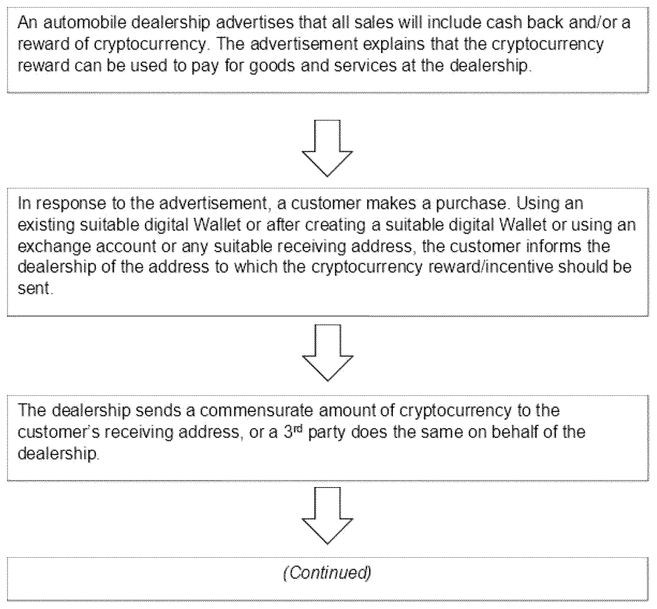

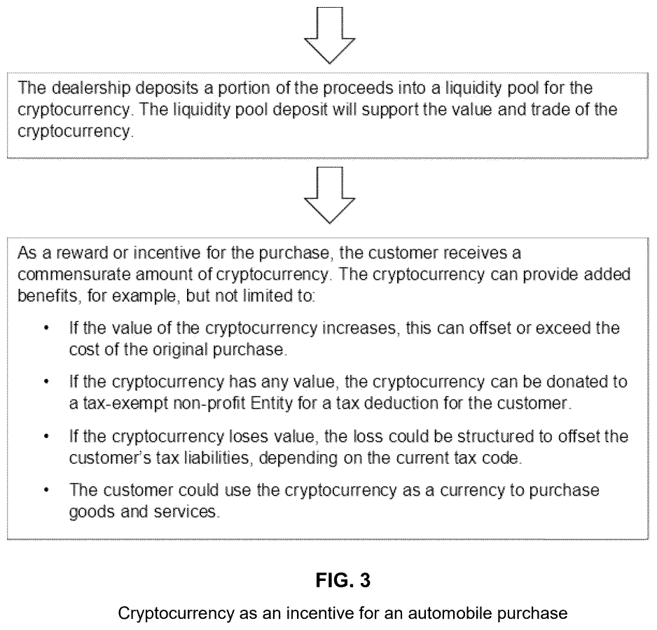

Drawings for FIG. 3. The process diagrams in FIG. 3 envision the use of the invention as a reward for an automobile dealer offering a cryptocurrency incentive to customers who purchase an automobile.

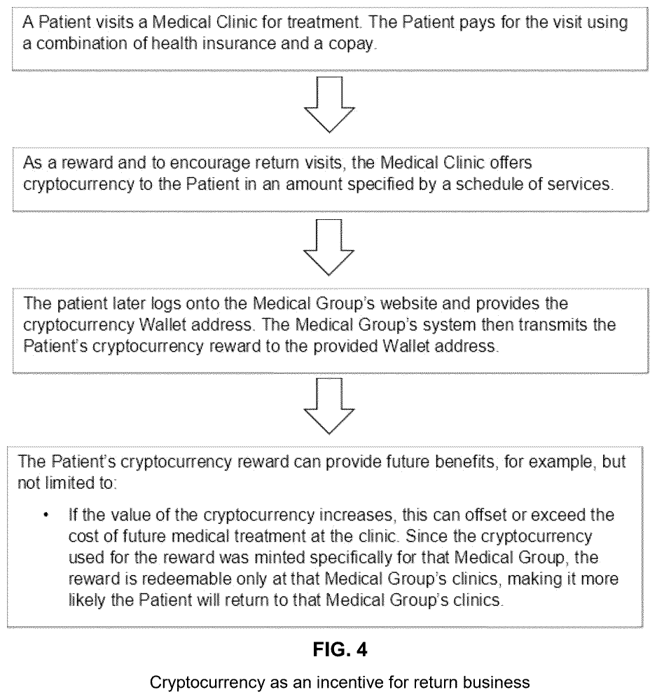

Drawings for FIG. 4. The process diagrams in FIG. 4 envision the use of the invention as a reward for a medical patient who visits a clinic owned by a Medical Group. For each visit, the patient receives a cryptocurrency reward, which can be used to pay for or offset the cost of future treatment.

### DETAILED DESCRIPTION OF DRAWINGS

Primary Components A-E. The primary components of this invention are:
A. One or more organizations desiring to conduct business transactions, such as, but not limited to, sales, services, memberships, or donations.
B. A second party (person(s) or organization(s)) to the business transaction(s), such as a customer.
C. A blockchain(s) supporting the cryptocurrency of the invention and accessible to the parties to the business transaction(s). The blockchain can pre-exist the invention. If not, the blockchain can be created for use by the invention. This component serves as both a transport medium and the cryptocurrency ledger,
D. A cryptocurrency(ies) in any form, such as, but not limited to, digital coins, digital tokens, and digital meme-coins. The cryptocurrency to be used might pre-exist the invention or be created for specific use by the invention.
E. Use of a cryptocurrency as a reward for a business transaction or an incentive to engage in business transaction(s). The amount awarded can correlate with the value of the underlying transaction(s), a predetermined schedule of the type of transaction, an amount negotiated by the concerned parties, or whatever arrangement meets the needs of the business or customer.

Optional Components F through K. Additional and optional components can be:
F. An Exchange(s) to support trading the rewarded cryptocurrency for another, perhaps more marketable, cryptocurrency.
G. An Exchange(s) to support the sale of the rewarded cryptocurrency, the proceeds of which can be deposited in an account with a bank.
H. A Wallet(s), suitable for cryptocurrency, to hold the rewarded cryptocurrency for as long as needed by the recipient and accessible online, aka hot storage.
I. An account(s) with a financial institution suitable for cryptocurrency, to hold the rewarded cryptocurrency for as long as needed by the recipient.
J. A Wallet(s), suitable for cryptocurrency, to hold the rewarded cryptocurrency for as long as needed by the recipient and accessible offline, such as on a USB stick or other offline storage, aka cold storage.
K. A liquidity pool to facilitate the sale, purchase, swapping, and pricing of Component D. The size of the pool can be set once or periodically or increased by a percentage of the transaction(s) value(s) or other arrangement. The liquidity pool will pay a portion of the transaction fees to the pool depositors. Whenever the liquidity pool(s) are closed, the pool amount can be returned to the original depositor.

Invention Components Order and Usage. In this invention, the above components will be used in the order and manner that best fits a particular line of business and the parties to the transactions of that business. Examples of the invention are laid out in the drawings that are part of this document and will aid in understanding the role the various components can play. The examples are not the only usages of the invention and its components. The invention is designed to be used by any business, such as but not limited to churches, humanitarian organizations, restaurants, investment firms, retail outlets, or business associations.

FIG. 1 “Cryptocurrency Reward delivered to a Donor's cryptocurrency Wallet” shows the use of the components A-E and H. FIG. 1 depicts cryptocurrency as a reward for a donation to a tax-exempt non-profit Entity. Component A (the tax-exempt non-profit Entity) receives a donation from Component B (the Donor). Based on the size of the donation, Component A sends a commensurate amount of Component D (the cryptocurrency), transmitted over and recorded on Component C (a blockchain) to Component H (the Donor's Wallet). This results in Component E, fulfilling the design of the invention. A portion of the donation is placed in Component K (a liquidity pool) to establish and support the value of the cryptocurrency. Component K will pay a portion of the transaction fees to the depositor.

FIG. 2 “Cryptocurrency Reward delivered to the Donor's offline storage”. FIG. 2 depicts cryptocurrency as a reward for a donation to a tax-exempt non-profit Entity. Component A (the tax-exempt non-profit Entity) receives a donation from Component B (the Donor). Based on the size of the donation, Component A sends a commensurate amount of Component D (the cryptocurrency), transmitted over and recorded on Component C (a blockchain) to Component J (the Donor's USB stick Wallet). This results in Component E, fulfilling the design of the invention. A portion of the donation is placed in Component K (a liquidity pool) to establish and support the value of the cryptocurrency. Component K will pay a portion of the transaction fees to the depositor.

FIG. 3 “Cryptocurrency as an incentive for an automobile purchase”. FIG. 3 depicts an automobile dealer offering a cryptocurrency incentive to customers who purchase an automobile. Component A (the automobile dealership) sells an automobile to Component B (the Customer). Based on the total sales price, Component A sends a commensurate amount of Component D (the cryptocurrency) to Component B, which is transmitted over and recorded on Component C (a blockchain) to Component H (the Customer's Wallet). This results in Component E, fulfilling the design of the invention. A portion of the sale is placed in Component K (a liquidity pool) to establish and support the value of the cryptocurrency. After the cryptocurrency is given to the customer, the automobile dealer later accepts the cryptocurrency in exchange for services, such as automobile maintenance and repair.

FIG. 4 “Cryptocurrency as an incentive for return business.” FIG. 4 depicts a Medical Group with several clinics in the metropolitan area that give their cryptocurrency as a reward to patients for their payment. The clinics accept the cryptocurrency as payment for services received or as a discount to the amount due. The cryptocurrency can also be purchased from an online Exchange. When the cryptocurrency is minted, the Medical Group creates Component K (a Liquidity Pool) to set the price for each coin of Component K. Component A (the Medical Group) provides medical care to Component B (the Patient). Component B pays for the services using insurance and a copay. Using a “Reward Schedule”, Component A sends a set amount of Component D (the cryptocurrency), transmitted over and recorded on Component C (a blockchain) to Component H (the patient's cryptocurrency Wallet). This results in Component E, fulfilling the design of the invention.

1. The present invention relates to the use of cryptocurrency by organization(s) or person(s) as an incentive or reward to other organization(s) or person(s) for sales, donations, investments, or any business transaction(s). In particular, the invention presents the necessary and optional components for using cryptocurrency as an incentive or reward for a business transaction(s) to increase the likelihood of success for that transaction(s) or to encourage repeat business.
